(19) United States
(12) Patent Application Publication
(10) Pub. No.: US 2005/0129353 A1
(43) Pub. Date: Jun. 16, 2005

(54) Optical deflector

(75) Inventors: Kazutoshi Torashima, Chigasaki-shi (JP); Yasushi Mizoguchi, Kawasaki-shi (JP); Yasuhiro Shimada, Sagamihara-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/000,064

(22) Filed: Dec. 1, 2004

(30) Foreign Application Priority Data
Dec. 15, 2003 (JP) 2003-416174

(51) Int. Cl. G02B 6/26

(52) U.S. Cl. 385/18

(57) ABSTRACT

An optical deflector is fixed in a box-shaped member and the box-shaped member has a through-hole and a light-transmissive portion for cutting off air inflow formed on a light reflection side of the optical deflector, whereby dust is prevented from attaching to a reflecting surface.

### BACKGROUND OF THE INVENTION

1. Field of the Invention

The present invention relates to an optical deflector fabricated by micromechanics technology.

2. Related Background Art

As represented by the high integration of semiconductor devices, various equipments have been reduced in size and improved in function in recent years with advance in microelectronics industry. The same applies to an apparatus utilizing a micromachine device through the micromechanics technology using a silicon process (for example, optical microdeflector, mechanical quantity microsensor or microactuator using a member which torsionally vibrates about a torsional axis). For example, a laser beam printer for performing optical scanning using an optical deflector, an image display such as a head mount display and a light capturing device of an input device such as a bar code reader are improved in function and decreased in size. Moreover, there is a need for further downsizing these units to enable them to be applied to a product that has, for example, such a shape as to easily carry.

As an example of torsionally vibratable optical deflector, there is one having the configuration shown in FIG. 4A, as disclosed in U.S. Pat. No. 4,317,611. FIG. 4B is a schematic exploded view showing the internal structure of the above optical deflector.

In the above optical deflector, a recessed portion 1011 is formed on a substrate 1010 made of an insulating material. On the bottom of the recessed portion 1011 are disposed a pair of driving electrodes 1012 and 1013 and a support portion 1014 for supporting a movable portion 1023. In a silicon substrate 1020, elastic support portions 1021 and 1022 and the movable portion 1023 are integrally formed. The surface of the movable portion 1023 is coated with a substance having a high reflectance, is supported so as to be torsionally vibratable by the elastic support portions 1021 and 1022 and is disposed in opposition to the insulating substrate 1010.

In this case, the silicon substrate 1020 is electrically grounded. Therefore, by alternately applying a voltage to the driving electrodes 1012 and 1013, it is possible to exert an electrostatic attraction force to the movable portion 1023 to torsionally vibrate the movable portion 1023 about major axes of the elastic support portions 1021 and 1022.

For further improvement in function and reduction in size of a laser beam printer for performing optical scanning using a micromachine device, an image display such as a head mount display, a light capturing device of an input device such as a bar code reader and the like, it is necessary to drive a movable portion at a high speed and a large deflection angle. However, when driving the movable portion at a high speed and a large deflection angle, an airflow will occur around the movable portion and the movable portion will serve as a pump. Therefore, in ambient air including much floating substance such as dust, the floating substance in the ambient air is attracted and attached to a reflection surface of the movable portion by air inflow. Therefore, the reflectance is lowered. The lowering of reflectance poses the problems that an image is deteriorated and image quality is not stabilized in a laser beam printer for performing optical scanning by using an optical deflector, an image display such as a head mount display or a light capturing device of an input device such as a bar code reader.

The present invention has been accomplished in view of the above-mentioned problems, and it is, therefore, an object of the present invention to provide an optical deflector capable of preventing ambient air containing floating substance from entering and attaching to a reflection surface by air inflow even when driving a movable portion at a high speed and a large deflection angle in ambient air in which floating substance such as dust is present, thereby preventing lowering of reflectance and degradation of image quality.

### SUMMARY OF THE INVENTION

The present invention provides optical deflectors described in Items (1) to (8) below in order to achieve the above-mentioned object.

(1) An optical deflector comprising a support substrate, a movable portion supported by an elastic support portion on the support substrate so as to be torsionally vibratable about a torsional axis and a reflecting surface formed on the movable portion and constructed to-drive the movable portion relative to the support substrate to deflect a light incident on the reflecting surface, wherein the optical deflector is fixed in a box-shaped member and the box-shaped member has a through-hole and a light-transmissive portion for cutting off air inflow formed on a light reflection side of the optical deflector.

(2) The optical deflector as set forth above, wherein the through-hole is formed on a side surface or a surface opposite to the light reflection side of the box-shaped member.

(3) The optical deflector as set forth above, wherein an antireflection coating is applied to the light-transmissive portion.

(4) The optical deflector as set forth above, wherein anti-water droplet coating is applied to the light-transmissive portion.

(5) The optical deflector as set forth above, wherein a light-transmissive surface of the light-transmissive portion is not set parallel to the reflecting surface.

(6) The optical deflector as set forth above, wherein the driving means is an electromagnetic actuator comprising a magnetic field generating portion for driving the movable portion and a movable core connected to the movable portion.

(7) The optical deflector as set forth above, wherein the box-shaped member comprises a soft magnetic material.

(8) An image forming apparatus using the optical deflector as set forth above.

The specific features of the present invention are as described above, and their details and functions are described below.

With the optical deflector in accordance with the present invention, even when the movable portion is driven at a high speed and a large deflection angle in ambient air including floating substance, air inflow is cut off and dust or the like cannot enter the reflecting surface, so that it is possible to prevent dust or the like from attaching to the reflecting surface, thereby preventing the lowering of reflectance and the degradation of image quality.

Moreover, the use of a soft magnetic material as the material for the box-shaped member makes it possible to drive the movable portion at a high speed and a large deflection angle with a low power consumption, and the provision of the light-transmissive portion enables air inflow to be cut off, thereby preventing floating substance or the like contained in ambient air from attaching to the reflecting surface.

Furthermore, because an image forming apparatus using the optical deflector of the present invention for vertical/horizontal scanning can prevent dust or the like from attaching to the reflecting surface, it is possible to prevent an image from deteriorating and stabilize image quality.

### BRIEF DESCRIPTION OF THE DRAWINGS

FIGS. 1A and 1B are an exploded view and a sectional view for explaining an optical deflector of Example 1 of the present invention;

FIGS. 2A and 2B are an exploded view and a sectional view for explaining an optical deflector of Example 2 of the present invention;

FIG. 3 is a schematic sectional view for explaining an optical deflector of Example 3 of the present invention; and

FIGS. 4A and 4B are a perspective view and an exploded view for explaining an optical deflector of the prior art.

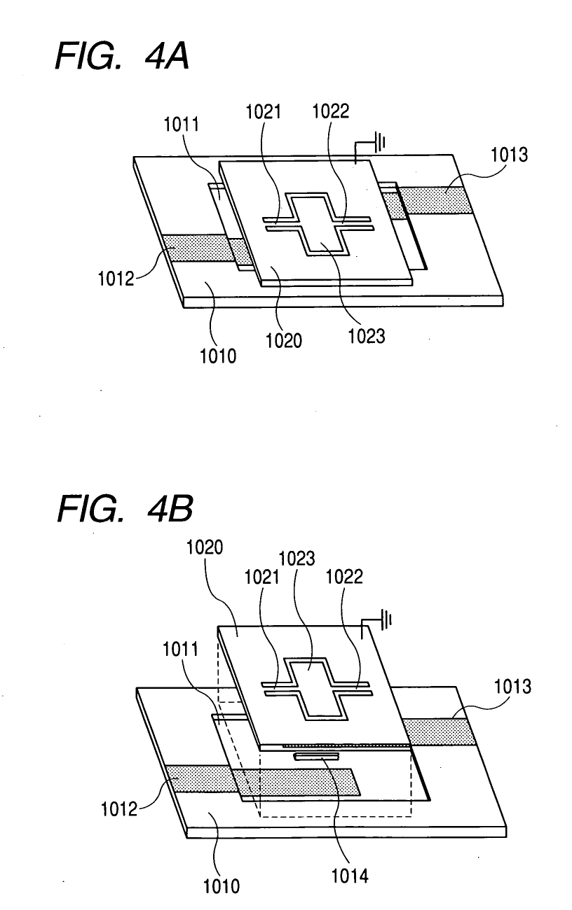

### DETAILED DESCRIPTION OF THE PREFERRED EMBODIMENTS

Embodiments of the present invention are described below.

First, reference numerals shown in the figures are described.

Reference numeral 110 denotes a glass substrate, 111 denotes a recessed portion, 112 and 113 each denote a driving electrode, 120 denotes a support substrate, 121 and 122 each denote an elastic support portion, 130 denotes a movable portion, 131 denotes a reflecting surface, 140 denotes a box-shaped member, 141 denotes a light-transmissive portion, 142 and 143 each denote a through-hole, 150 denotes a torsional axis, 210 denotes a coil substrate, 220 denotes a support substrate, 221 and 222 each denote an elastic support portion, 230 denotes a movable portion, 231 denotes a reflecting surface, 232 denotes a movable core, 240 denotes a coil, 250 denotes a box-shaped member, 251 denotes a light-transmissive portion, 252 and 253 each denote a through-hole, 260 denotes a torsional axis, 301 and 302 each denote an optical deflector, 311 denotes a laser light source, 321 denotes a light intensity modulator, 331 denotes a lens, 341 denotes a laser light, 351 denotes a projection plane, 1010 denotes an insulating substrate, 1011 denotes a recessed portion, 1012 and 1013 each denote a driving electrode, 1014 denotes a support portion, 1020 denotes a silicon substrate, 1021 and 1022 each denote an elastic support portion and 1023 denotes a movable portion.

In the case of the optical deflector having the features set forth in Items (1) and (2) above, a movable portion is supported by an elastic support portion on a support substrate so as to be torsionally vibratable about a torsional axis and a film having a high reflectance such as an aluminum film, a dielectric multilayer film or the like is formed on one side of the movable portion to form a reflecting surface. Moreover, by vibrating the movable portion from the outside, the movable portion can be driven relative to the support substrate to deflect a light incident on the reflecting surface. When driving the movable portion at a high speed and a large deflection angle, an airflow will occur around the movable portion. Therefore, when the deflector is located in ambient air in which floating substance such as dust is present, the floating substance will enter the reflecting surface by air inflow and will attach to the reflecting surface. Therefore, the present invention has a feature that an optical deflector is fixed in a box-shaped member and a light reflecting surface side of the box-shaped member is formed of a light-transmissive portion for cutting off air inflow. According to the present invention having these specific features, even when an airflow occurs around the movable portion by driving the movable portion at a high speed and a large deflection angle in ambient air in which floating substance such as dust is present, it is possible to cut off air inflow and prevent floating substance from entering the reflecting surface because the light reflecting surface side of the box-shaped member is covered with the light-transmissive portion. Therefore, floating substance will not attach to the reflecting surface. Moreover, a through-hole may be provided at a side surface or a surface opposite to the light reflection surface of the box-shaped member. The through-hole is located at a position that is less influenced by an airflow caused by driving the movable portion. The through-hole can reduce differences in pressure and temperature between the outside and the inside. Therefore, it is possible to decrease deflection of the light-transmissive portion flow of outside air into the box-shaped member and temperature change due to heat generation of the optical deflector. Thus, providing a through-hole at a side surface or a surface opposite to the light reflection surface of the box-shaped member can reduce differences in pressure and temperature between the outside and the inside thereby decreasing flow of outside air into the box-shaped member, and forming the light reflecting surface side of a light-transmissive portion for cutting off air inflow makes it possible to prevent the reflectance of the reflecting surface from lowering.

Moreover, as set forth in Item (3) above, the light-transmissive portion may be coated with an antireflection film in order to suppress the reflection of light to improve the transmittance. When a part of reflected light when light enters the front surface (or rear surface) of the light-transmissive portion is reflected again by the rear surface (or front surface) of the light-transmissive portion, a ghost is generated. By coating the light-transmissive portion with an antireflection film such as a dielectric film in a single layer or multilayer, it is possible to prevent a ghost.

Furthermore, as set forth in Item (4) above, the light-transmissive portion may be coated with a anti-water droplet film. After a water droplet adheres to the light-transmissive portion and is then dried, the transmittance of the light-transmissive portion is lowered due to water scale or the like. Therefore, by applying an anti-water droplet film such as fluorine coating to the light-transmissive portion, it is possible to prevent the water scale due to adhesion of a water droplet.

Moreover, with the feature set forth in Item (5) above, by setting a light-transmissive surface of the light-transmissive portion nonparallel to the reflecting surface, it is possible to prevent a light reflected from the light-transmissive portion from forming a ghost on a projection plane.

Furthermore, in the feature as set forth in Item (6) above, as means for vibrating the movable portion, a magnetic field generating portion such as a coil for driving the movable portion is formed and a bulky permanent magnet having a large magnetic moment is used as a movable core for the movable portion to constitute an electromagnetic actuator. In the optical deflector constituted as described above, the torque T applied to the permanent magnet by a magnetic field generated by means of the magnetic field generating portion is given by the following equation (1):
T=H×M (1)
wherein T is a generated torque, H is a magnetic field generated by a coil, and M is a magnetic moment of a permanent magnet. By using the bulky permanent magnet having a large magnetic moment as a movable core, it is possible to increase M of the equation (1). Because the magnetic moment M is large, the generated torque T is large even when the magnetic field generated by the coil is small. That is, it is possible to increase the generated torque while decreasing a current to be supplied to the coil. Therefore, it becomes possible to drive the movable portion at a high speed and a large deflection angle with a low power consumption.

For example, when applying a micromachine device to a product having such a shape as to easily carry, it is necessary to drive a movable portion at a high speed and a large deflection angle with a low power consumption, thereby preventing lowering of the reflectance and degradation of the image quality. In the case of the optical deflector having the configuration using the electromagnetic actuator of the present invention, it is possible to drive a movable portion at a high speed and a large deflection angle with a low power consumption, and a through-hole of the box-shaped member can reduce differences in pressure and temperature between the outside and the inside thereby decreasing deflection of the light-transmissive portion, flow of outside air into the box-shaped member and temperature change due to heat generation of the optical deflector. Moreover, because floating substance can be prevented from entering the reflecting surface of the movable portion by the light-transmissive portion for cutting off air inflow, it is possible to prevent the image quality from being degraded.

Furthermore, in the configuration set forth in Item (7) above, the movable portion is driven by an electromagnetic actuator; the light reflecting surface side is covered with a light-transmissive portion; and a soft magnetic material is used as the material for the box-shaped member. In the optical deflector constituted as described above, it is possible to apply a magnetic field generated by a coil to a movable core without leakage to the outside.

Moreover, in the case of a conventional optical deflector used for an image forming apparatus, dust or the like will attach to a reflecting surface to lower the reflectance, thereby degrading the image quality. However, as set forth in Item (8) above, by using the optical deflector having the feature set forth in Items (1) to (7), it is possible to cut off air inflow to prevent floating substance from attaching to the reflecting surface, whereby it is possible to form a stable image without lowering the reflectance.

The present invention is described below in detail with reference to examples thereof.

### EXAMPLE 1

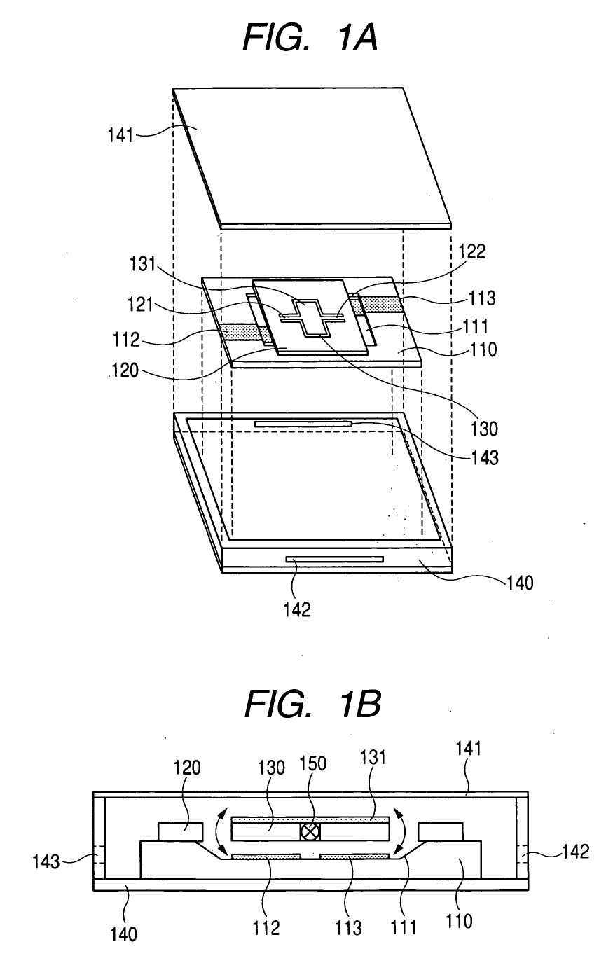

FIGS. 1A and 1B are schematic views for explaining an optical deflector of Example 1 of the present invention. FIG. 1A is an exploded view showing the optical deflector of Example 1 and FIG. 1B is a sectional view of the deflector. In the optical deflector of Example 1, a recessed portion 111 is formed on a glass substrate 110. A pair of driving electrodes 112 and 113 are disposed at the bottom of the recessed portion 111. On a single-crystal-silicon support substrate 120, elastic support portions 121 and 122 and a movable portion 130 are integrally formed through the bulk micromachining technique. A surface of the movable portion 130 is coated with a material such as an aluminum film or dielectric multilayer film having a high reflectivity to form a reflecting surface 131.

The movable portion 130 is supported by the elastic support portions 121 and 122 so as to be torsionally vibratable about a torsional axis 150. Moreover, the single-crystal-silicon support substrate 120 is disposed on the glass substrate 110 such that a predetermined interval is kept between the movable portion 130 and the driving electrodes 112 and 113.

The single-crystal-silicon support substrate 120 is electrically grounded. Therefore, by alternately applying a voltage to the driving electrodes 112 and 113, it is possible to exert an electrostatic attraction force to the movable portion 130 to torsionally vibrate the movable portion 130 about the torsional axis 150. By resonantly driving the movable portion 130 at a frequency that is the same as the natural mode of torsional vibration of the movable portion, it is possible to attain a large deflection angle. The driving force is not limited to an electrostatic attraction force but includes an electromagnetic force or the like. In this case, a configuration may be adopted in which an electromagnet is disposed instead of the driving electrode, while a permanent magnetic of a hard magnetic material or the like is fixed to the lower surface of the movable portion 130.

This example has a feature that the optical deflector is fixed in a box-shaped member 140 and the light reflecting surface 131 side of the box-shaped member 140 is formed of a light-transmissive portion 141 for cutting off air inflow. Moreover, through-holes 142 and 143 are provided at sidewalls of the box-shaped member 150 that are less influenced by an airflow caused by driving the movable portion 130.

When driving the movable portion 130 at a high speed and a large deflection angle, an airflow occurs around the movable portion 130. Therefore, in ambient air in which floating substance such as dust is present, floating substance enters the reflecting surface 131 due to air inflow and dust or the like attaches to the reflecting surface 131. By covering the light reflecting surface 131 side of the box-shaped member 140 with the light-transmissive portion 141, even when the movable portion 130 is driven at a high speed and a large deflection angle in ambient air in which floating substance such as dust is present, it is possible to cut off air inflow and prevent floating substance from entering the reflecting surface 131. Moreover, because the through-holes 142 and 143 provided in the sidewalls of the box-shaped member 150 can reduce a pressure difference between the outside and the inside and a temperature change due to heat generation by the optical deflector, it is possible to reduce deflection of the light-transmissive portion, inflow of outside air containing floating substance and temperature change of the optical deflector.

With the optical deflector of this example constituted as described above, when the movable portion was driven at a high speed and a large deflection angle of a driving frequency of 20 kHz and a light deflection angle of ±10° or more, air inflow was cut off to prevent floating substance from flowing into the reflecting surface 131. Therefore, dust or the like was prevented from attaching to the reflecting surface 131, thereby preventing lowering of the reflectance and degradation of the image quality.

### EXAMPLE 2

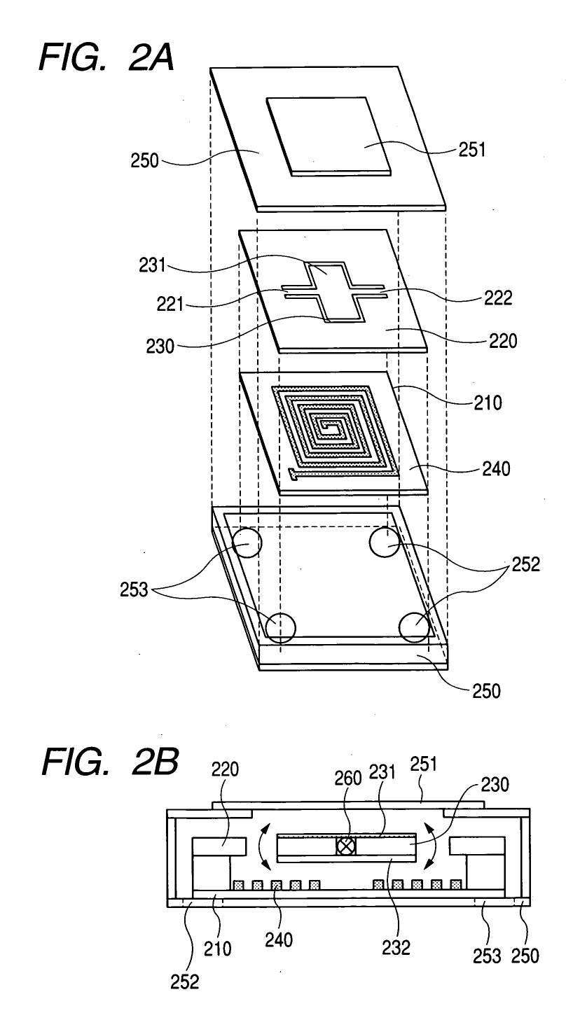

FIGS. 2A and 2B are schematic views for explaining an optical deflector of Example 2 of the present invention. FIG. 2A is an exploded view showing the internal structure of the optical deflector of Example 2 and FIG. 2B is a sectional view of the deflector. In the optical deflector of Example 2, a planar coil 240 is formed on a coil substrate 210 by the micromachining technique. The planar coil 240 has a single layer or multilayer structure. On a single-crystal-silicon support substrate 220, elastic support portions 221 and 222 and a movable portion 230 are integrally formed. The movable portion has a size of 1,500 μm×1,300 μm and a thickness of 200 μm. One surface of the movable portion 230 is coated with a material having a high reflectance such as an aluminum film or dielectric multilayer film to form a reflecting surface 231 and a hard magnetic material is disposed on the opposite side as a movable core 232. The movable core 232 is magnetized perpendicularly to a torsional axis 260. Moreover, the movable portion is supported by the elastic support portions 221 and 222 so as to be torsionally vibratable about the torsional axis 260. The support substrate 220 is disposed on the coil substrate 210 such that a predetermined interval is kept between the movable portion 230 and the planar coil 240.

A torque T applied to the permanent magnet by a magnetic field generated by the coil 240 (magnetic field generating portion) is given by the following equation (1):
T=H×M (1)
wherein T represents a generated torque; H represents a magnetic field generated by the coil; and M represents a magnetic moment of the permanent magnet. An alloy magnet containing Fe, Cr and Co is a bulky permanent magnet that can easily be machined and has a large magnetic moment. Therefore, by using this permanent magnet as the movable core 232, it is possible to increase M in the equation (1). Because the magnetic moment M is large, the generated torque T is large even when the magnetic field generated by the coil 240 is small. That is, it is possible to increase the generated torque while decreasing a current to be supplied to the coil 240.

The present example has a feature that the optical deflector driven by the electromagnetic actuator is fixed in a box-shaped member 250 made of a soft magnetic material, the light reflecting surface side of the box-shaped member is covered with a light-transmissive portion 251, and through-holes 252 and 253 are provided on the side opposite to the light reflection side of the box-shaped member 250.

By forming the box-shaped member 250 of a soft magnetic material, for example, a soft magnetic material containing Fe and Ni as major components, it is possible to decrease leakage to the outside of the magnetic field generated by the coil 240 and efficiently apply the magnetic field to the movable core 232, so that driving at a high speed and a large deflection angle with a low power consumption is realized.

Moreover, when driving the movable portion 230 at a high speed and a large deflection angle, an airflow occurs around the movable portion 230. Therefore, floating substance enters the reflecting surface 231 due to air inflow and dust or the like attaches to the reflecting surface 231. By covering the light reflecting surface 231 side of the box-shaped member 250 with the light-transmissive portion 251, even when the movable portion 230 is driven at a high speed and a large deflection angle in ambient air in which floating substance such as dust is present, because air inflow is cut off, it is possible to prevent floating substance from entering the reflecting surface 231. Moreover, because the through-holes 252 and 253 are provided on the side opposite to the light reflection side of the box-shaped member 250, it is possible to reduce a pressure difference between the outside and the inside and a temperature change due to heat generation by the optical deflector, whereby it is possible to reduce deflection of the light-transmissive portion, inflow of outside air containing floating substance and temperature change of the optical deflector.

To prevent reflection of light and improve the transmittance, antireflection coating is applied to the light-transmissive portion 251. As an example of antireflection coating, a dielectric film is may be formed in a single layer or multilayer structure.

With the configuration of this example, it was possible with a low power consumption of 0.2 W or less to drive the movable portion at a high speed and a large deflection angle of a driving frequency of 20 kHz and a light deflection angle of ±20° or more. Further, even when driving the movable portion in ambient air, floating substance did not attach to the reflecting surface and lowering of the reflectance could be prevented.

When the optical deflector having the configuration using an electromagnetic actuator of this example is applied to a product having such a shape as to easily carry, it is possible to drive the movable portion at a high speed and a large deflection angle with a low power consumption and cut off air inflow to prevent floating substance from attaching to the reflecting surface 231. Therefore, it is possible to prevent the image quality from being degraded.

### EXAMPLE 3

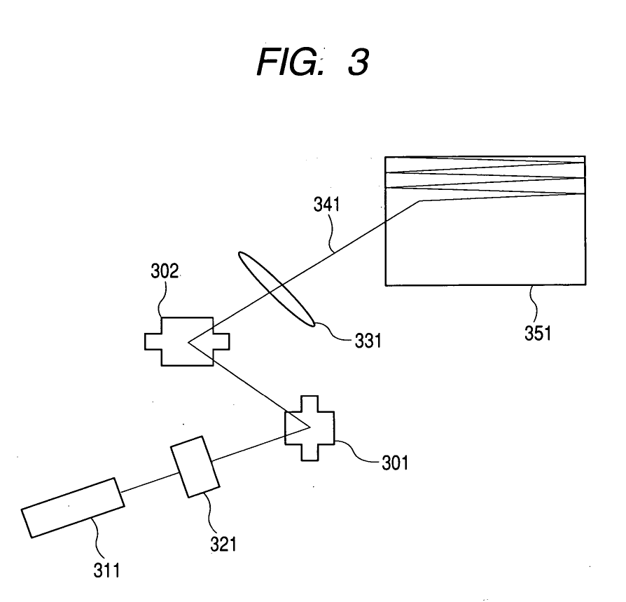

This example shows an image forming apparatus using the optical deflector of the present invention. FIG. 3 is a schematic view for explaining the image forming apparatus of this example. By disposing optical deflectors 301 and 302 in accordance with Example 1 or 2 such that their deflection directions are perpendicular to each other, it is possible to scan an incident light vertically and horizontally. A laser light 341 emitted from a laser light source 311 is modulated in intensity by a light intensity modulator 321 and two-dimensionally scanned by the optical deflectors 301 and 302. As the laser light source 311, light sources of red, blue and green colors may be used and subjected to light-color mixing by means of a color-mixing light source system. The scanned laser beam 341 can form an image on a projection plane 351 by a lens 331.

In the case of a conventional image forming apparatus that adopts the above-mentioned image forming system, the reflectance of a reflecting surface will be lowered to lower the light intensity on the projection plane. As described in this example, by using the optical deflector of the present invention capable of preventing dust and the like from attaching to the reflecting surface, it is possible to prevent the image from deteriorating.

This application claims priority from Japanese Patent Application No. 2003-416174 filed Dec. 15, 2003, which is hereby incorporated by reference herein.

1. An optical deflector comprising a support substrate, a movable portion supported by an elastic support portion on the support substrate so as to be torsionally vibratable about a torsional axis and a reflecting surface formed on the movable portion and constructed to drive the movable portion relative to the support substrate to deflect a light incident on the reflecting surface, wherein the optical deflector is fixed in a box-shaped member and the box-shaped member has a through-hole and a light-transmissive portion for cutting off air inflow formed on a light reflection side of the optical deflector.

2. The optical deflector according to claim 1, wherein the through-hole is formed on a side surface or a surface opposite to the light reflection side of the box-shaped member.

3. The optical deflector according to claim 1, wherein an antireflection coating is applied to the light-transmissive portion.

4. The optical deflector according to claim 1, wherein anti-water droplet coating is applied to the light-transmissive portion.
a water-droplet preventive coating is applied to the light-transmissive portion.

5. The optical deflector according to claim 1, wherein a light-transmissive surface of the light-transmissive portion is not set parallel to the reflecting surface.

6. The optical deflector according to claim 1, wherein the driving means is an electromagnetic actuator comprising a magnetic field generating portion for driving the movable portion and a movable core connected to the movable portion.

7. The optical deflector according to claim 1, wherein the box-shaped member comprises a soft magnetic material.

8. An image forming apparatus comprising the optical deflector set forth in claim 1.
